(19) United States
(12) Patent Application Publication
(10) Pub. No.: US 2025/0266961 A1
(43) Pub. Date: Aug. 21, 2025

(54) INDICATION METHOD AND DEVICE/STORAGE MEDIUM/APPARATUS FOR PHYSICAL CHANNEL REPEAT TRANSMISSION

(71) Applicant: Beijing Xiaomi Mobile Software Co., Ltd., Beijing (CN)

(72) Inventors: Yajun ZHU, Beijing (CN); Yuanyuan LI, Beijing (CN); Junli LI, Beijing (CN)

(73) Assignee: Beijing Xiaomi Mobile Software Co., Ltd., Beijing (CN)

(21) Appl. No.: 18/857,354

(22) PCT Filed: Apr. 20, 2022
(86) PCT No.: PCT/CN2022/088002

§ 371 Date: Oct. 16, 2024

(51) Int. Cl. H04L 5/00; H04W 72/11; H04W 72/21

(52) U.S. Cl. CPC H04L 5/0053; H04W 72/11; H04W 72/21

(57) ABSTRACT

The present disclosure provides a method and a device/storage medium/apparatus for indicating repetition transmission of a physical channel The method includes: receiving configuration information for repetition transmission sent by a network device; determining a transmission resource for the repetition transmission according to the configuration information, wherein the transmission resource is discontinuous in time; and determining a repetition transmission opportunity according to the transmission resource.

### CROSS-REFERENCE TO RELATED APPLICATION

The application is a U.S. National Stage of International Application No. PCT/CN2022/088002 filed on Apr. 20, 2022, the entire content of which is incorporated herein by reference.

### TECHNICAL FIELD

The present disclosure relates to the technical field of communication, and in particular, to a method and device/storage medium/apparatus for indicating repetition transmission of a physical channel.

### BACKGROUND

In the new radio (NR) system, repetition transmission is introduced to enhance signal coverage.

In the related art, for a physical downlink shared channel (PDSCH), only the transmission on the same time domain symbol in consecutive slots is supported; and for a physical uplink shared channel (PUSCH), the following two repetition transmission modes are supported:
Type A: the PUSCH is repeatedly transmitted on the same time domain symbol in each consecutive slot;
Type B: the PUSCH may be repeatedly transmitted based on mini-slots and may cross boundaries of slots.

In the process of repetition transmission, it may usually be necessary to terminate the transmission in advance. For the repetition transmission of the PUSCH, when a downlink control information (DCI) scheduling of the same process is received and the DCI indicates new data, the hybrid automatic repeat request-acknowledge character (HARQ-ACK) feedback of the uplink process is implicitly indicated as ACK, then subsequent repetition transmission is no longer needed.

### SUMMARY

The present disclosure provides a method and device/storage medium/apparatus for indicating repetition transmission of a physical channel.

A method for indicating repetition transmission of a physical channel provided in an embodiment of one aspect of the present disclosure is applied to a UE and includes: receiving configuration information for repetition transmission sent by a network device; determining a transmission resource for the repetition transmission according to the configuration information, where the transmission resource is discontinuous in time; and determining a repetition transmission opportunity according to the transmission resource.

A method for indicating repetition transmission of a physical channel provided in an embodiment of another aspect of the present disclosure is applied to a network device and includes:
sending configuration information for repetition transmission to a UE.

An apparatus for indicating repetition transmission of a physical channel provided in an embodiment of an aspect of the present disclosure includes:
a receiving module, configured to receive configuration information for repetition transmission sent by a network device;
a first determining module, configured to determine a transmission resource for the repetition transmission according to the configuration information, where the transmission resource is discontinuous in time; and
a second determining module, configured to determine a repetition transmission opportunity according to the transmission resource.

An apparatus for indicating repetition transmission of a physical channel provided in an embodiment of another aspect of the present disclosure includes: a sending module, configured to send configuration information for repetition transmission to a UE.

Another aspect of the present disclosure provides a communication apparatus, which includes a processor and a memory, where a computer program is stored in the memory, and the processor executes the computer program stored in the memory to cause the apparatus to perform the method provided in the embodiments of the above-mentioned aspect.

Another aspect of the present disclosure provides a communication apparatus, which includes a processor and a memory, where a computer program is stored in the memory, and the processor executes the computer program stored in the memory to cause the apparatus to perform the method provided in the embodiments of the above-mentioned another aspect.

A communication apparatus provided in still another aspect of the present disclosure includes: a processor and an interface circuit;
the interface circuit is configured to receive code instructions and transmit the code instructions to the processor; and
the processor is configured to run the code instructions to perform the method provided in the embodiments of one aspect.

A communication apparatus provided in still another aspect of the present disclosure includes: a processor and an interface circuit;
the interface circuit is configured to receive code instructions and transmit the code instructions to the processor; and
the processor is configured to run the code instructions to perform the method provided in the embodiments of the other aspect.

A computer-readable storage medium provided in yet another aspect of the present disclosure is configured to store instructions, and the instructions, when being executed, cause the method provided in the embodiments of one aspect to be implemented.

A computer-readable storage medium provided in yet another aspect of the present disclosure is configured to store instructions, and the instructions, when being executed, cause the method provided in the embodiments of the other aspect to be implemented.

Additional aspects and advantages of the present disclosure will be given in part in the following description, and the part will become obvious from the following description or will be learned through the practice of the present disclosure.

### BRIEF DESCRIPTION OF THE DRAWINGS

The above and/or additional aspects and advantages of the present disclosure will become obvious and easily understood from the following description of the embodiments with reference to the accompanying drawings.

FIG. 1a is a schematic flow chart of a method for indicating repetition transmission of a physical channel provided by an embodiment of the present disclosure;

FIG. 1b is a schematic diagram of a structure of pattern information of the repetition transmission provided by an embodiment of the present disclosure;

FIG. 1c is a schematic diagram of a structure of repetition transmission opportunities determined based on a time interval between each repetition transmission opportunity provided by an embodiment of the present disclosure;

FIG. 2 is a schematic flow chart of a method for indicating repetition transmission of a physical channel provided by another embodiment of the present disclosure;

FIG. 3a is a schematic flow chart of a method for indicating repetition transmission of a physical channel provided by yet another embodiment of the present disclosure;

FIG. 3b is a schematic flow chart of a method for indicating repetition transmission of a physical channel provided by still another embodiment of the present disclosure;

FIG. 3c is a schematic flow chart of a method for indicating repetition transmission of a physical channel provided by still another embodiment of the present disclosure;

FIG. 4 is a schematic flow chart of a method for indicating repetition transmission of a physical channel provided by still another embodiment of the present disclosure;

FIG. 5a is a schematic flow chart of a method for indicating repetition transmission of a physical channel provided by still another embodiment of the present disclosure;

FIG. 5b is a schematic flow chart of a method for indicating repetition transmission of a physical channel provided by still another embodiment of the present disclosure;

FIG. 5c is a schematic flow chart of a method for indicating repetition transmission of a physical channel provided by still another embodiment of the present disclosure;

FIG. 6 is a schematic flow chart of a method for indicating repetition transmission of a physical channel provided by still another embodiment of the present disclosure;

FIG. 7 is a schematic diagram of a structure of an apparatus for indicating repetition transmission of a physical channel provided by an embodiment of the present disclosure;

FIG. 8 is a schematic diagram of a structure of an apparatus for indicating repetition transmission of a physical channel provided by another embodiment of the present disclosure;

FIG. 9 is a block diagram of a user equipment provided by an embodiment of the present disclosure;

FIG. 10 is a block diagram of a base station provided by an embodiment of the present disclosure.

### DETAILED DESCRIPTION

Exemplary embodiments will be described in detail herein, examples of which are represented in the accompanying drawings. When the following description relates to the drawings, the same numerals in different accompanying drawings represent the same or similar elements unless otherwise indicated. The implementations described in the following exemplary embodiments do not represent all implementations consistent with the embodiments of the present disclosure. To the contrary, they are merely examples of apparatuses and methods that are consistent with some aspects of the embodiments of the present disclosure, as detailed in the appended claims.

Terms used in the embodiments of the present disclosure are used solely for the purpose of describing certain embodiments and are not intended to limit the embodiments of the present disclosure. The singular forms of “a/an” and “the” used in the embodiments of the present disclosure and the appended claims are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the embodiments of the present disclosure, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “when . . . ” or “in the case . . . ” or “in response to determination”.

The embodiments of the present disclosure are described in detail below, and examples of the embodiments are shown in the accompanying drawings, where the same or similar reference numerals throughout represent the same or similar elements. The embodiments described below with reference to the accompanying drawings are exemplary and are intended to be used to explain the present disclosure, and should not be construed as limiting the present disclosure.

In the related art, consecutive slots are used for performing retransmission, thus in non-terrestrial networks (NTN), it may not be able to match the time domain channel variability in the NTN channel, resulting in poor communication quality. In addition, for the above-mentioned case of early termination of transmission, in NTN, due to the large round trip time (RTT), when the base station finds that the transmission may be terminated after receiving part of the retransmission and sends DCI to the UE, and the UE receives the DCI scheduling of the same process and the DCI indicates new data, all retransmissions may have been completed, which results in a waste of resources.

The present disclosure provides a method and device/storage medium/apparatus for indicating repetition transmission of a physical channel, so as to provide a method suitable for repetition transmission in the NTN.

The following describes in detail the method and device/storage medium/apparatus for indicating repetition transmission of a physical channel provided by the present disclosure with reference to the accompanying drawings.

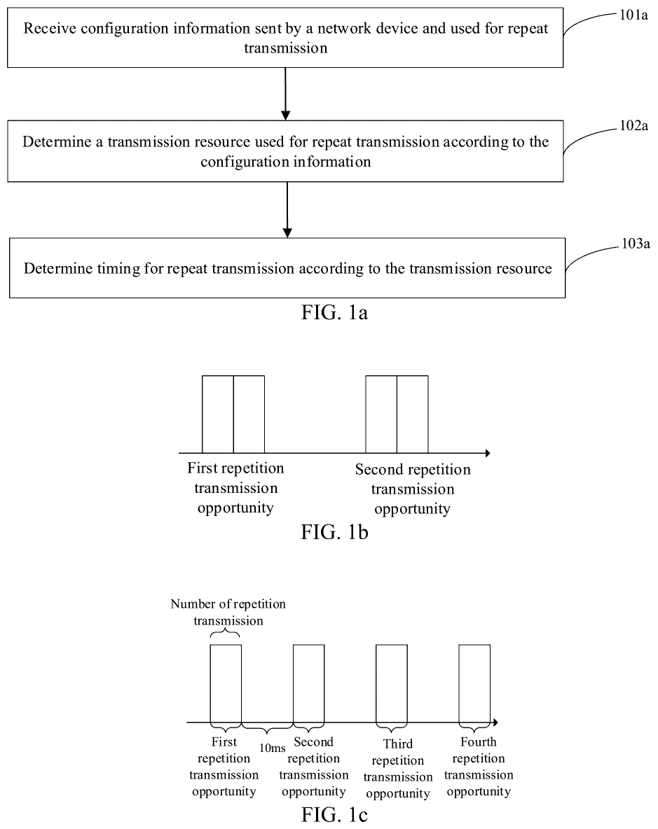

FIG. 1a is a schematic flow chart of a method for indicating repetition transmission of a physical channel provided by an embodiment of the present disclosure, which is applied to a UE. As shown in FIG. 1a, the method for indicating the repetition transmission of the physical channel may include the following steps.

In step 101a, configuration information for repetition transmission sent by a network device is received.

It should be noted that, in an embodiment of the present disclosure, the UE may refer to a device that provides voice and/or data connectivity to a user. The terminal device may communicate with one or more core networks via a radio access network (RAN). The UE may be an IoT terminal, such as a sensor device, a mobile phone (or referred to as a “cellular” phone), and a computer with an IoT terminal, for example, it may be a fixed, portable, pocket-sized, handheld, computer-built-in, or vehicle-mounted apparatus, e.g., a station (STA), a subscriber unit, a subscriber station, a mobile station, a mobile, a remote station, an access point, a remote terminal, an access terminal, a user terminal, or a user agent. Alternatively, the UE 11 may be a device of an unmanned aerial vehicle. Alternatively, the UE may be a vehicle-mounted device, for example, it may be a trip computer with a wireless communication function, or a wireless terminal externally connected to a trip computer. Alternatively, the UE may be a roadside device, for example, a street lamp, a signal lamp, or other roadside devices with a wireless communication function.

In an embodiment of the present disclosure, the present embodiment may be applicable to an NTN system.

In an embodiment of the present disclosure, the repetition transmission of the physical channel may include at least one of the following:
repetition transmission of a PUSCH;
repetition transmission of a PDSCH;
repetition transmission of a physical uplink control channel (PUCCH); and
repetition transmission of a physical downlink control channel (PDCCH).

Furthermore, in an embodiment of the present disclosure, the configuration information may include a specific transmission resource used for the repetition transmission and/or indication information, and the indication information may be used to indicate the transmission resource for the repetition transmission of the physical channel. Furthermore, the transmission resource is discontinuous in time. The transmission resource may specifically include at least one of the following:
a total number of repetition transmission; where the total number of repetition transmission may be a total number of transmission opportunities;
a time interval between each repetition transmission opportunity;
a number of repetition transmission transmitted at each repetition transmission opportunity; and pattern information of repetition transmission (where the pattern information of repetition transmission may be used to determine the above time interval and/or the number of repetition transmission transmitted at each repetition transmission opportunity).

It should be noted that, in an embodiment of the present disclosure, the above-mentioned transmission resource may be predetermined by the network device according to the RTT and/or the current channel quality, so that the intervals between the determined transmission resources can match the RTT, thereby avoiding the situation where “the UE has completed all the repetition transmissions when the UE receives the information for terminating the retransmission sent by the network device, as a result of performing retransmissions by using consecutive transmission opportunities”, thereby reducing useless transmissions and saving power consumption.

In addition, in an embodiment of the present disclosure, when the content in the above configuration information is different, the method of receiving the configuration information sent by the network device in this step will also be different, and the embodiment of this part will be introduced in detail later.

In step 102a, a transmission resource for the repetition transmission is determined according to the configuration information.

In an embodiment of the present disclosure, the transmission resource for the repetition transmission determined in this step may include, for example: the total number of the repetition transmission, the time interval between each repetition transmission opportunity, and the number of the repetition transmission transmitted at each repetition transmission opportunity. When the number of the repetition transmission transmitted at each repetition transmission opportunity is not indicated, the UE may adopt a default value, which may be but not limited to 1, that is, the number of the repetition transmission transmitted at each repetition transmission opportunity is 1.

Further, in another embodiment of the present disclosure, the transmission resource for the repetition transmission determined in this step may include, for example: the total number of the repetition transmission, and the pattern information of the repetition transmission, and the pattern information of the repetition transmission may at least be used to indicate the time interval between each repetition transmission opportunity in the repetition transmission process and/or the number of the repetition transmission transmitted at each repetition transmission opportunity. FIG. 1b is a structural schematic diagram of the pattern information of the repetition transmission provided in an embodiment of the present disclosure. Referring to FIG. 1b, the repetition transmission process indicated by the pattern information of the repetition transmission includes two repetition transmission opportunities, namely a first repetition transmission opportunity and a second repetition transmission opportunity, and the pattern information of the repetition transmission also indicates that the number of the repetition transmission transmitted at each repetition transmission opportunity is 2.

In addition, the total number of the repetition transmission mentioned above may be configured by the network device to the UE. “The time interval between each repetition transmission opportunity, the number of the repetition transmission transmitted at each repetition transmission opportunity, and the pattern information of the repetition transmission” may be configured by the network device to the UE, or may be determined by the UE based on predefined information. The details of this part will be introduced in subsequent embodiments.

In step 103a, a repetition transmission opportunity is determined according to the transmission resource.

In an embodiment of the present disclosure, when the transmission resource determined by the UE in the above step 102a is different, the method for determining the repetition transmission opportunity will also be different.

Specifically, in an embodiment of the present disclosure, when the transmission resource determined based on step 102a includes: the total number of the repetition transmission, the time interval between each repetition transmission opportunity, and the number of the repetition transmission transmitted at each repetition transmission opportunity, the UE may determine the repetition transmission opportunity based on the transmission resource as follows: the UE first determines a first repetition transmission opportunity (for example, the UE may determine the time point of receiving the indication information sent by the network device that instructs the UE to start the repetition transmission as the first repetition transmission opportunity), and then determines each repetition transmission opportunity of the UE based on the first repetition transmission opportunity, the time interval between each repetition transmission opportunity, and the total number of the repetition transmission.

Exemplarily, in an embodiment of the present disclosure, FIG. 1c is a schematic diagram of a structure of the repetition transmission opportunities determined based on the time interval between each repetition transmission opportunity provided by an embodiment of the present disclosure. It is assumed that the transmission resource for the repetition transmission determined in step 102a is as follows: the total number of the repetition transmission being 4, and the time interval between each repetition transmission opportunity being 10 ms. Then, referring to FIG. 1c, the UE determines the first repetition transmission opportunity, and may determine an opportunity 10 ms apart from the first repetition transmission opportunity as a second repetition transmission opportunity, an opportunity 10 ms apart from the second repetition transmission opportunity as a third repetition transmission opportunity, and an opportunity 10 ms apart from the third repetition transmission opportunity as a fourth repetition transmission opportunity, thereby determining each repetition transmission opportunity.

Further, in another embodiment of the present disclosure, when the transmission resource for the repetition transmission determined based on step 102a includes the pattern information of the repetition transmission, each repetition transmission opportunity may be directly determined according to the pattern information of the repetition transmission (for example, the pattern information of the repetition transmission as shown in FIG. 1b).

In summary, in the method for indicating repetition transmission of the physical channel provided in the embodiment of the present disclosure, the UE may receive the configuration information for the repetition transmission sent by the network device, determine the transmission resource for the repetition transmission according to the configuration information, the transmission resource being discontinuous in time, and determine the repetition transmission opportunity according to the transmission resource. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmissions when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

FIG. 2 is a schematic flow chart of another method for indicating repetition transmission of a physical channel provided in an embodiment of the present disclosure, which is applied to a UE. As shown in FIG. 2, the method for indicating the repetition transmission of the physical channel may include the following steps.

In step 201, a corresponding relationship between indication information and a transmission resource sent by a network device via a first signaling is received.

In an embodiment of the present disclosure, the transmission resource may include at least one of the following:
a total number of the repetition transmission; where the total number of the repetition transmission may be a total number of transmission opportunities;
a time interval between each repetition transmission opportunity;
a number of the repetition transmission transmitted at each repetition transmission opportunity; and
pattern information of the repetition transmission (where the pattern information of the repetition transmission may be used to determine the above time interval and/or the number of the repetition transmission transmitted at each repetition transmission opportunity).

In addition, in an embodiment of the present disclosure, the transmission resource is discontinuous in time.

Further, in an embodiment of the present disclosure, the first signaling may be a radio resource control (RRC) signaling, and the UE may receive the corresponding relationship between the indication information and the transmission resource sent by the network device via the RRC signaling, where different indication information corresponds to different transmission resources, and the indication information may be an index (index value) and/or a bit value. In an embodiment of the present disclosure, the number of bits of the bit value may be N bit, where N is a positive integer.

Specifically, in an embodiment of the present disclosure, when the indication information is a bit value, the UE may receive a corresponding relationship between the transmission resource (such as the time interval between each repetition transmission opportunity) and the bit value of a specific field in a second signaling sent by the network device via the RRC signaling.

In addition, in an embodiment of the present disclosure, when the indication information is the index, the UE may first receive a start and length indicator value (SLIV) table sent by a network device via the RRC signaling, where the SLIV table includes the corresponding relationship between the transmission resource and the indication information, for example, a certain column in the SLIV table may be used to indicate the time interval between each repetition transmission opportunity, and each row of the SLIV table corresponds to one index.

In step 202, the indication information sent by the network device via a second signaling is received.

In an embodiment of the present disclosure, the second signaling may be a DCI signaling.

Specifically, in an embodiment of the present disclosure, when the UE receives the corresponding relationship between the bit value and the transmission resource (such as the time interval between each repetition transmission opportunity) sent by the network device via the first signaling according to step 201a, the indication information in this step may be the bit value carried in a specific domain of the second signaling, then the UE may determine the specific transmission resource according to the received bit value and the corresponding relationship, such as the specific time interval between each repetition transmission opportunity.

In addition, in an embodiment of the present disclosure, when the UE receives the SLIV table sent by the network device via the first signaling according to step 201a, the indication information in this step may be the index carried in the second signaling, and the UE may determine the corresponding transmission resource based on the index and the SLIV table.

Furthermore, in an embodiment of the present disclosure, the above-mentioned method of receiving configuration information sent dynamically by the network device via RRC signaling and DCI signaling may be applicable to dynamically scheduled data channels.

In step 203, a corresponding transmission resource is determined based on the corresponding relationship in the first signaling and the indication information included in the second signaling.

To be specific, in an embodiment of the present disclosure, the UE may determine the corresponding transmission resource by using the corresponding relationship between the indication information and the transmission resource sent by the network device via the first signaling and the indication information in the second signaling.

Exemplarily, in an embodiment of the present disclosure, it is assumed that the 5th column in the received SLIV table sent by the network device via RRC signaling is used to indicate the transmission resource, which indicates pattern information of the repetition transmission 1, pattern information of the repetition transmission 2, pattern information of the repetition transmission 3, pattern information of the repetition transmission 4, and pattern information of the repetition transmission 5, respectively, and the index corresponding to the pattern information of the repetition transmission 1, the pattern information of the repetition transmission 2, the pattern information of the repetition transmission 3, the pattern information of the repetition transmission 4, and the pattern information of the repetition transmission 5 are 2, 4, 6, 8, and 10 respectively, and, it is assumed that the DCI signaling sent by the network device and received by the UE includes index 4, then the pattern information of the repetition transmission 2 may be determined as the transmission resource based on the SLIV table and the index being 4.

In another embodiment of the present disclosure, it is assumed that the corresponding relationship between the bit value and the transmission resource sent by the network device via RRC signaling is as follows: bit value 00 corresponding to pattern information of the repetition transmission 1, bit value 01 corresponding to pattern information of the repetition transmission 2, bit value 10 corresponding to pattern information of the repetition transmission 3, and bit value 11 corresponding to pattern information of the repetition transmission 4. Further, it is assumed that the DCI signaling sent by the network device and received by the UE includes the bit value 00. Then the pattern information of the repetition transmission 1 is determined as the transmission resource based on the corresponding relationship between the bit value and the transmission resource and the bit value being 00.

In step 204, a repetition transmission opportunity is determined according to the transmission resource.

In an embodiment of the present disclosure, the detailed description of step 203 may refer to the relevant description in the above embodiment, which will not be repeated by the embodiment of the present disclosure herein.

In summary, in the method for indicating repetition transmission of the physical channel provided in the embodiment of the present disclosure, the UE may receive the configuration information for the repetition transmission sent by the network device, determine the transmission resource for the repetition transmission according to the configuration information, where the transmission resource is discontinuous in time, and determine the repetition transmission opportunities according to the transmission resource. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmissions when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

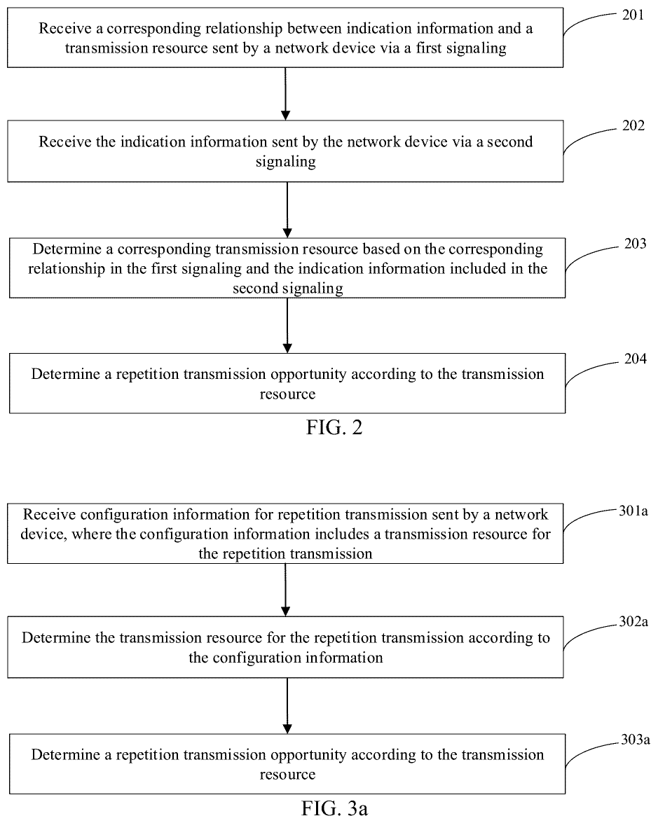

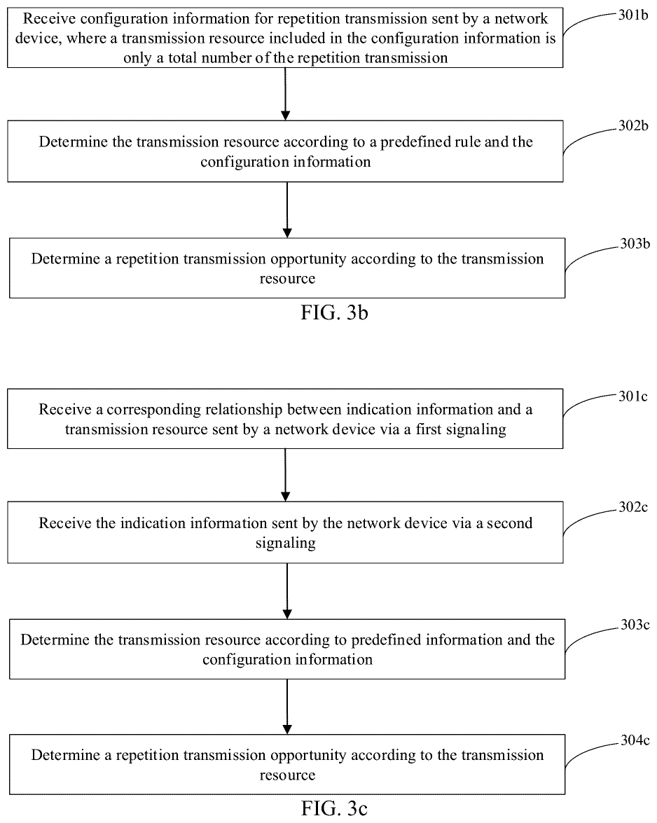

FIG. 3a is a schematic flow chart of another method for indicating repetition transmission of a physical channel provided in an embodiment of the present disclosure, which is applied to a UE. As shown in FIG. 3a, the method for indicating the repetition transmission of the physical channel may include the following steps.

In step 301a, configuration information for repetition transmission sent by a network device is received, where the configuration information includes a specific transmission resource used for the repetition transmission.

In an embodiment of the present disclosure, the above transmission resource may include at least one of the following:
a total number of the repetition transmission; where the total number of the repetition transmission may be a total number of transmission opportunities;
a time interval between each repetition transmission opportunity;
a number of the repetition transmission transmitted at each repetition transmission opportunity; and
pattern information of the repetition transmission (where the pattern information of the repetition transmission may be used to determine the above time interval and/or the number of the repetition transmission transmitted at each repetition transmission opportunity).

In addition, in an embodiment of the present disclosure, the transmission resource is discontinuous in time.

That is, in an embodiment of the present disclosure, the configuration information may include the specific transmission resource, for example, may directly include the total number of the repetition transmission and the time interval between each repetition transmission opportunity.

Further, in an embodiment of the present disclosure, the method of receiving the configuration information for the repetition transmission sent by the network device may include: receiving the configuration information sent by the network device through a third signaling.

In addition, in an embodiment of the present disclosure, the third signaling may be an RRC signaling, and receiving the configuration information sent by the network device via the third signaling may include any one of the following:
receiving the configuration information sent by the network device via an RRC signaling for configuring semi-persistent scheduling (SPS), i.e., directly configuring the transmission resource in the configuration of configuring the SPS;
receiving the configuration information sent by the network device via an RRC signaling for configuring a physical uplink shared channel configured grant type 1 (PUSCH configured grant type 1), i.e., directly configuring the transmission resource in the configuration of configuring PUSCH configured grant type 1; and
receiving the configuration information sent by the network device via an RRC signaling for configuring a physical channel, i.e., directly configuring the transmission resource in the configuration of configuring the physical channel.

In another embodiment of the present disclosure, the method of receiving the configuration information for the repetition transmission sent by the network device may include: receiving the configuration information sent by the network device via a fourth signaling.

In an embodiment of the present disclosure, the fourth signaling may be a DCI signaling, and the method of receiving the configuration information sent by the network device via the fourth signaling may include any one of the following:
receiving the configuration information sent by the network device via a DCI signaling for activating SPS; and
receiving the configuration information sent by the network device via a DCI signaling for activating PUSCH configured grant type 2.

In step 302a, a transmission resource for the repetition transmission is determined according to the configuration information.

In an embodiment of the present disclosure, since the configuration information received in step 301a includes the specific transmission resource used for the repetition transmission, in this step, the content included in the configuration information may be directly determined as the transmission resource.

In step 303a, a repetition transmission opportunity is determined according to the transmission resource.

In an embodiment of the present disclosure, the detailed description of step 303a may refer to the relevant description in the above embodiments, which will not be repeated by the embodiment of the present disclosure herein.

In summary, in the method for indicating repetition transmission of the physical channel provided in the embodiment of the present disclosure, the UE may receive the configuration information for the repetition transmission sent by the network device, determine the transmission resource for the repetition transmission according to the configuration information, where the transmission resource is discontinuous in time, and determine the repetition transmission opportunities according to the transmission resource. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmissions when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

FIG. 3b is a schematic flow chart of another method for indicating repetition transmission of a physical channel provided in an embodiment of the present disclosure, which is applied to a UE. As shown in FIG. 3b, the method for indicating the repetition transmission of the physical channel may include the following steps.

In step 301b, configuration information for repetition transmission sent by a network device is received, where a transmission resource included in the configuration information is a total number of the repetition transmission.

In step 302b, the transmission resource for the repetition transmission is determined according to predefined information and the configuration information.

In response to the configuration information in step 301b above, only the total number of the repetition transmission may be determined. Therefore, other transmission resources may be determined based on the predefined information.

In an embodiment of the present disclosure, the predefined information may be used to determine at least one of the following:
a time interval between each repetition transmission opportunity;
a number of the repetition transmission transmitted at each repetition transmission opportunity; and
pattern information of the repetition transmission.

Based on this, in an embodiment of the present disclosure, the UE can determine the transmission resource for the repetition transmission based on the predefined information in conjunction with the configuration information.

Exemplarily, when the network device configures only the total number of the repetition transmission through the configuration information, the time interval between each repetition transmission opportunity and the number of the repetition transmission transmitted at each repetition transmission opportunity may be determined based on predefined information, or the pattern information of the repetition transmission may be determined based on predefined information. In this manner, the UE can determine all transmission resources required for the repetition transmission of the physical channel based on the received configuration information and the predefined information.

In step 303b, a repetition transmission opportunity is determined according to the transmission resource.

In an embodiment of the present disclosure, the detailed description of step 303b may refer to the relevant description in the above embodiments, which will not be repeated by the embodiment of the present disclosure herein.

In summary, in the method for indicating repetition transmission of the physical channel provided in the embodiment of the present disclosure, the UE may receive the configuration information for the repetition transmission sent by the network device, determine the transmission resource for the repetition transmission according to the configuration information, where the transmission resource is discontinuous in time, and determine the repetition transmission opportunities according to the transmission resource. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmissions when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

FIG. 3c is a schematic flow chart of another method for indicating repetition transmission of a physical channel provided in an embodiment of the present disclosure, which is applied to a UE. As shown in FIG. 3c, the method for indicating the repetition transmission of the physical channel may include the following steps.

In step 301c, a corresponding relationship between indication information and a transmission resource sent by a network device via a first signaling is received.

In step 302c, the indication information sent by the network device via a second signaling is received, the transmission resource corresponding to the indication information carried in configuration information (which may be understood as the corresponding relationship in step 301c and the indication information in step 302c) only includes a total number of the repetition transmission.

In step 303c, a transmission resource is determined according to predefined information and the configuration information.

In response to the configuration information in step 302c above, only the total number of the repetition transmission may be determined. Therefore, other transmission resources may be determined based on the predefined information.

In an embodiment of the present disclosure, the predefined information may be used to determine at least one of the following:
a time interval between each repetition transmission opportunity;
a number of the repetition transmission transmitted at each repetition transmission opportunity; and
pattern information of the repetition transmission.

Based on this, in an embodiment of the present disclosure, the UE can determine the transmission resource for the repetition transmission based on the predefined information in conjunction with the configuration information.

Exemplarily, when the network device configures only the total number of the repetition transmission through the configuration information, the time interval between each repetition transmission opportunity and the number of the repetition transmission transmitted at each repetition transmission opportunity may be determined based on predefined information, or the pattern information of the repetition transmission may be determined based on predefined information. In this manner, the UE can determine all transmission resources required for the repetition transmission of the physical channel based on the received configuration information and the predefined information.

In step 304c, a repetition transmission opportunity is determined according to the transmission resource.

In an embodiment of the present disclosure, the detailed description of step 304c may refer to the relevant description in the above embodiments, which will not be repeated by the embodiment of the present disclosure herein.

In summary, in the method for indicating repetition transmission of the physical channel provided in the embodiment of the present disclosure, the UE may receive the configuration information for the repetition transmission sent by the network device, determine the transmission resource for the repetition transmission according to the configuration information, where the transmission resource is discontinuous in time, and determine the repetition transmission opportunities according to the transmission resource. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmissions when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

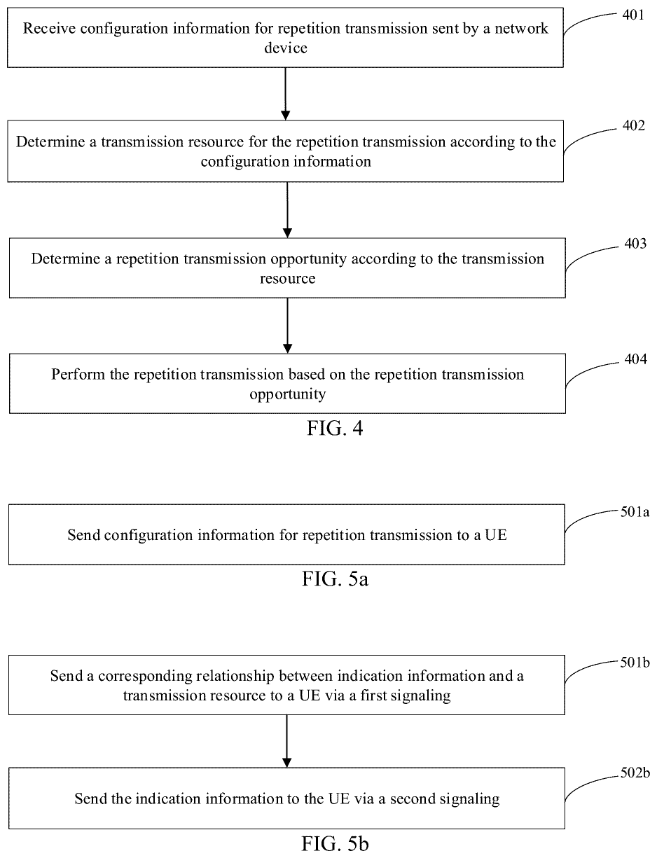

FIG. 4 is a schematic flow chart of another method for indicating repetition transmission of a physical channel provided in an embodiment of the present disclosure, which is applied to a UE. As shown in FIG. 4, the method for indicating the repetition transmission of the physical channel may include the following steps.

In step 401, configuration information for repetition transmission sent by a network device is received.

In step 402, a transmission resource for the repetition transmission is determined according to the configuration information.

In step 403, a repetition transmission opportunity is determined according to the transmission resource.

For a detailed description of steps 401 to 403, reference may be made to the related description in the above embodiments, which will not be repeated by the embodiment of the present embodiment herein.

In step 404, the repetition transmission is performed based on the repetition transmission opportunity.

In an embodiment of the present disclosure, the repetition transmission is performed specifically based on the respective transmission opportunity determined in step 403.

In summary, in the method for indicating repetition transmission of the physical channel provided in the embodiment of the present disclosure, the UE may receive the configuration information for the repetition transmission sent by the network device, determine the transmission resource for the repetition transmission according to the configuration information, where the transmission resource is discontinuous in time, and determine the repetition transmission opportunities according to the transmission resource. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmissions when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

FIG. 5a is a schematic flow chart of another method for indicating repetition transmission of a physical channel provided in an embodiment of the present disclosure, which is applied to a network device. As shown in FIG. 5a, the method for indicating the repetition transmission of the physical channel may include the following steps: In step 501a, configuration information for repetition transmission is sent to UE.

Further, in an embodiment of the present disclosure, the repetition transmission of the physical channel may include at least one of the following:
repetition transmission of a PUSCH;
repetition transmission of a PDSCH;
repetition transmission of a PUCCH; and
repetition transmission of a PDCCH.

In addition, in an embodiment of the present disclosure, when the content in the above configuration information is different, the method of sending the configuration information to the UE in this step will also be different, and the embodiment of this part will be introduced in detail later.

For other detailed descriptions of this embodiment, reference may be made to the relevant descriptions in the above embodiments.

In summary, in the method for indicating repetition transmission of the physical channel provided in the embodiment of the present disclosure, the network device may send the configuration information for the repetition transmission to the UE. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmissions when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

FIG. 5b is a schematic flow chart of another method for indicating repetition transmission of a physical channel provided in an embodiment of the present disclosure, which is applied to a network device. As shown in FIG. 5b, the method for indicating the repetition transmission of the physical channel may include the following steps:
In step 501b, a corresponding relationship between indication information and a transmission resource is sent to the UE via a first signaling.

In an embodiment of the present disclosure, the transmission resource may include at least one of the following:
a total number of the repetition transmission;
a time interval between each repetition transmission opportunity;
a number of the repetition transmission transmitted at each repetition transmission opportunity; and
pattern information of the repetition transmission.

Further, in an embodiment of the present disclosure, the above first signaling may be an RRC signaling, and the method of sending the corresponding relationship between the indication information and the transmission resource to the UE via the first signaling may include: sending the corresponding relationship between the indication information and the transmission resource to the UE via the RRC signaling.

In an embodiment of the present disclosure, the above indication information may be an index and/or a bit value.

When the indication information is the bit value, specifically, in an embodiment of the present disclosure, the network device may send the corresponding relationship between the transmission resource (such as the time interval between each repetition transmission opportunity) and the bit value of a specific field in the DCI via RRC signaling.

Further, in an embodiment of the present disclosure, when the indication information is the index, the network device may send an SLIV table via RRC signaling, where the SLIV table includes a corresponding relationship between the transmission resource and the indication information, for example, a certain column in the SLIV table may be used to indicate the time interval between each repetition transmission opportunity, and each row of the SLIV table corresponds to one index.

In step 502b, the indication information is sent to the UE via a second signaling.

In an embodiment of the present disclosure, the above second signaling may be a DCI signaling, and the method of sending the indication information to the UE via the second signaling may include: sending the indication information to the UE via the DCI signaling.

Further, in an embodiment of the present disclosure, the indication information may be an index (index value) and/or a bit value.

In an embodiment of the present disclosure, the transmission resource indicated by the indication information is discontinuous in time.

For other detailed descriptions of this embodiment, reference may be made to the relevant descriptions in the above embodiments.

In summary, in the method for indicating repetition transmission of the physical channel provided in the embodiment of the present disclosure, the network device may send the configuration information for the repetition transmission to the UE. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmission when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

FIG. 5c is a schematic flow chart of another method for indicating repetition transmission of a physical channel provided in an embodiment of the present disclosure, which is applied to a network device. As shown in FIG. 5c, the method for indicating the repetition transmission of the physical channel may include the following steps.

In step 501c, configuration information for repetition transmission is sent to the UE, where the configuration information includes a transmission resource for the repetition transmission.

In an embodiment of the present disclosure, the above transmission resource may include at least one of the following:
a total number of the repetition transmission;
a time interval between each repetition transmission opportunity;
a number of the repetition transmission transmitted at each repetition transmission opportunity; and
pattern information of the repetition transmission.

In addition, in an embodiment of the present disclosure, the transmission resource included in the above configuration information is discontinuous in time.

Further, in an embodiment of the present disclosure, the method of sending the configuration information to the UE by the network device may include: sending the configuration information to the UE via a third signaling.

In an embodiment of the present disclosure, the third signaling may be an RRC signaling, and the method of sending the configuration information to the UE by the network device via the third signaling may include any one of the following:
sending the configuration information to the UE via an RRC signaling for configuring SPS;
sending the configuration information to the UE via an RRC signaling for configuring a PUSCH configured grant Type 1; and
sending the configuration information to the UE via an RRC signaling for configuring a physical channel.

Further, in an embodiment of the present disclosure, the physical channel includes at least one of the following:
PUSCH;
PDSCH;
PUCCH; and
PDCCH.

Further, in another embodiment of the present disclosure, the method of sending the configuration information to the UE by the network device may include: sending the configuration information to the UE via a fourth signaling.

In an embodiment of the present disclosure, the fourth signaling may be a DCI signaling, and the method of sending the configuration information to the UE by the network device via the fourth signaling may include any one of the following:
sending the configuration information to the UE via a DCI signaling for activating SPS; and
sending the configuration information to the UE via a DCI signaling for activating a PUSCH configured grant type 2.

For other detailed descriptions of this embodiment, reference may be made to the relevant descriptions in the above embodiments.

In summary, in the method for indicating repetition transmission of the physical channel provided in the embodiment of the present disclosure, the network device may send the configuration information for the repetition transmission to the UE. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmission when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

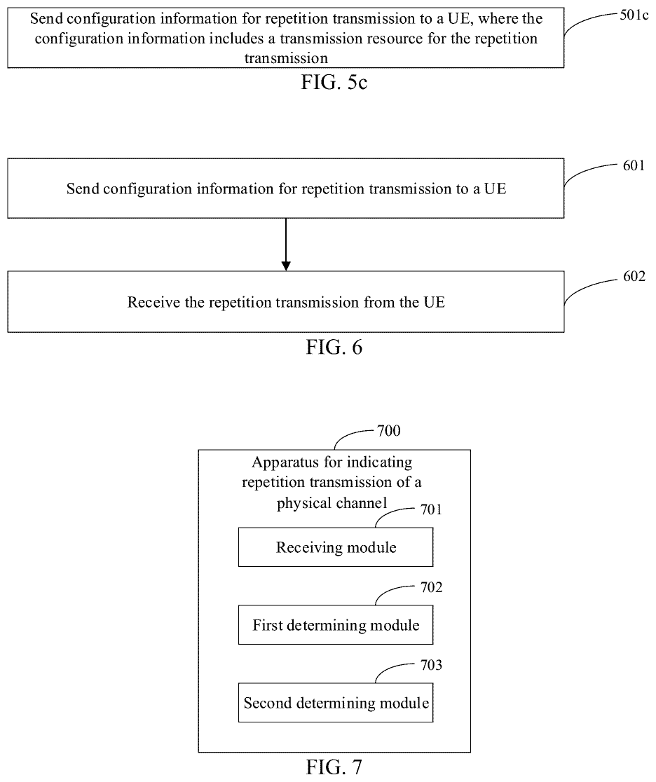

FIG. 6 is a schematic flow chart of another method for indicating repetition transmission of a physical channel provided in an embodiment of the present disclosure, which is applied to a network device. As shown in FIG. 6, the method for indicating the repetition transmission of the physical channel may include the following steps.

In step 601, configuration information for repetition transmission is sent to UE.

In step 602, the repetition transmission from the UE is received.

In an embodiment of the present disclosure, the network device may receive the repetition transmission from the UE based on configuration information sent to the UE.

In summary, in the method for indicating repetition transmission of the physical channel provided in the embodiment of the present disclosure, the network device may send the configuration information for the repetition transmission to the UE. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmission when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

FIG. 7 is a schematic diagram of a structure of an apparatus for indicating repetition transmission of a physical channel provided by an embodiment of the present disclosure. As shown in FIG. 7, the apparatus 700 may include:
a receiving module 701, configured to receive configuration information for repetition transmission sent by a network device;
a first determining module 702, configured to determine a transmission resource for the repetition transmission according to the configuration information, where the transmission resource is discontinuous in time; and
a second determining module 703, configured to determine a repetition transmission opportunity according to the transmission resource.

In summary, in the apparatus for indicating repetition transmission of the physical channel provided in the embodiment of the present disclosure, the UE may receive the configuration information for the repetition transmission sent by the network device, determine the transmission resource for the repetition transmission according to the configuration information, where the transmission resource is discontinuous in time, and determine the repetition transmission opportunities according to the transmission resource. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmission when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

Further, in another embodiment of the present disclosure, the receiving module 701 is further configured to:
receive a corresponding relationship between indication information and the transmission resource sent by the network device via a first signaling; and receive the indication information sent by the network device via a second signaling.

In an embodiment of the present disclosure, the transmission resource includes at least one of the following:
a total number of the repetition transmission;
a time interval between each repetition transmission opportunity;
a number of the repetition transmission transmitted at each repetition transmission opportunity; and
pattern information of the repetition transmission.

Further, in another embodiment of the present disclosure, the above first determining module 702 is further configured to:
determine a corresponding transmission resource based on the corresponding relationship of the first signaling and the indication information included in the second signaling.

Further, in another embodiment of the present disclosure, the configuration information includes the transmission resource for the repetition transmission, and the transmission resource includes at least one of the following:
a total number of the repetition transmission;
a time interval between each repetition transmission opportunity;
a number of the repetition transmission transmitted at each repetition transmission opportunity; and
pattern information of the repetition transmission.

Further, in another embodiment of the present disclosure, the above receiving module 701 is further configured to:
receive the configuration information sent by the network device via a third signaling.

Further, in another embodiment of the present disclosure, the third signaling is an RRC signaling, and the above receiving module 701 is further configured to:
receive the configuration information sent by the network device via an RRC signaling for configuring SPS;
receive the configuration information sent by the network device via an RRC signaling for configuring a PUSCH configured grant Type 1; or
receive the configuration information sent by the network device via an RRC signaling for configuring a physical channel.

Furthermore, in another embodiment of the present disclosure, the above receiving module 701 is further configured to:
receive the configuration information sent by the network device via a fourth signaling.

Further, in another embodiment of the present disclosure, the fourth signaling is a DCI signaling, and the receiving module 701 is further configured to:
receive the configuration information sent by the network device via a DCI signaling for activating SPS; or
receive the configuration information sent by the network device via a DCI signaling for activating PUSCH configured grant type 2.

Further, in another embodiment of the present disclosure, in response to the transmission resource included in the configuration information being a total number of the repetition transmission, the first determining module 702 is further configured to:

determine the transmission resource according to predefined information and the configuration information;
where the predefined information is used to determine at least one of:
a time interval between each repetition transmission opportunity;
a number of the repetition transmission transmitted at each repetition transmission opportunity; and
pattern information of the repetition transmission.

Further, in another embodiment of the present disclosure, the transmission resource corresponding to the indication information carried in the configuration information includes a total number of the repetition transmission, and the first determining module 702 is further configured to:
determine the transmission resource according to predefined information and the configuration information;
where the predefined information is used to determine at least one of:
a time interval between each repetition transmission opportunity;
a number of the repetition transmission transmitted at each repetition transmission opportunity; and
pattern information of repetition transmission.

Further, in another embodiment of the present disclosure, the repetition transmission of the physical channel includes at least one of the following:
repetition transmission of a PUSCH;
repetition transmission of a PDSCH;
repetition transmission of a PUCCH; and
repetition transmission of a PDCCH.

Furthermore, in another embodiment of the present disclosure, the above apparatus is further configured to:
perform the repetition transmission based on the repetition transmission opportunity.

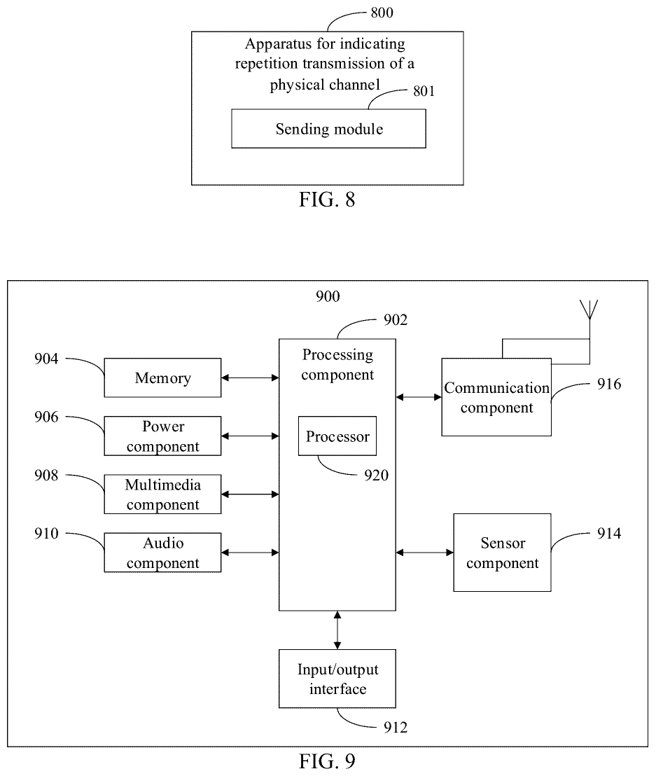

FIG. 8 is a schematic diagram of a structure of an apparatus for indicating repetition transmission of a physical channel provided by another embodiment of the present disclosure. As shown in FIG. 8, the apparatus 800 may include:
a sending module 801, configured to send configuration information for repetition transmission to a UE.

In summary, in the method for indicating repetition transmission of the physical channel provided in the embodiment of the present disclosure, the network device may send the configuration information for the repetition transmission to the UE. It can be seen that in the embodiment of the present disclosure, the UE can perform repetition transmission by using the discontinuous transmission resource, that is, there is a time interval between each transmission opportunity. Based on this, when the UE performs retransmission at a certain transmission opportunity in the NTN system, if the network device finds that the transmission may be terminated and sends information for terminating the retransmission to the UE, at the moment when the UE receives the information for terminating the retransmission, it may not reach the next transmission opportunity, thereby avoiding the occurrence of the situation in which “the UE has completed all the repetition transmission when the UE receives the information for terminating the retransmission sent by the network device, as a result of performing retransmissions by using consecutive transmission opportunities”, thereby reducing useless transmission and saving power consumption. In addition, the retransmission based on the discontinuous transmission resource in the present disclosure can also match the time domain channel variability in the NTN channel to ensure communication quality.

In an embodiment of the present disclosure, the above sending module 801 is further configured to:
send a corresponding relationship between indication information and a transmission resource to the UE via a first signaling; and send the indication information to the UE via a second signaling.

Further, in another embodiment of the present disclosure, the transmission resource includes at least one of the following:
a total number of the repetition transmission;
a time interval between each repetition transmission opportunity;
a number of the repetition transmission transmitted at each repetition transmission opportunity; and
pattern information of the repetition transmission.

Further, in another embodiment of the present disclosure, the configuration information includes a transmission resource for the repetition transmission, and the transmission resource includes at least one of the following:
a total number of the repetition transmission;
a time interval between each repetition transmission opportunity;
a number of the repetition transmission transmitted at each repetition transmission opportunity; and
pattern information of the repetition transmission.

Further, in another embodiment of the present disclosure, the above sending module 801 is further configured to:
send the configuration information to the UE via a third signaling.

Further, in another embodiment of the present disclosure, the third signaling is an RRC signaling, and the sending module 801 is further configured to:
send the configuration information to the UE via an RRC signaling for configuring SPS;
send the configuration information to the UE via an RRC signaling for configuring a PUSCH configured grant Type 1;
send the configuration information to the UE via an RRC signaling for configuring a physical channel.

Further, in another embodiment of the present disclosure, the sending module 801 is further configured to:
send the configuration information to the UE via a fourth signaling.

Further, in another embodiment of the present disclosure, the fourth signaling is a DCI signaling, and the sending module 801 is further configured to:
send the configuration information to the UE via a DCI signaling for activating SPS;
send the configuration information to the UE via a DCI signaling for activating a PUSCH configured grant type 2.

Furthermore, in another embodiment of the present disclosure, the above apparatus is further configured to:
receive the repetition transmission from the UE.

Further, in another embodiment of the present disclosure, the repetition transmission of the physical channel includes at least one of the following:
repetition transmission of a PUSCH;
repetition transmission of a PDSCH;
repetition transmission of a PUCCH; and
repetition transmission of a PDCCH.

FIG. 9 is a block diagram of a user equipment (UE) 900 provided by an embodiment of the present disclosure. For example, the UE 900 may be a mobile phone, a computer, a digital broadcast terminal device, a messaging device, a gaming console, a tablet, a medical device, an exercise equipment, a personal digital assistant, and the like.

Referring to FIG. 9, the UE 900 may include one or more of the following components: a processing component 902, a memory 904, a power component 906, a multimedia component 908, an audio component 910, an input/output (I/O) interface 912, a sensor component 913, and a communication component 916.

The processing component 902 typically controls overall operation of the UE 900, such as the operations associated with display, telephone calls, data communications, camera operations, and recording operations. The processing component 902 may include one or more processors 920 to execute instructions to generate all or part of the steps of the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the UE 900. Examples of such data include instructions for any applications or methods operated on the UE 900, contact data, phonebook data, messages, pictures, videos, etc. The memory 904 may be implemented using any type of volatile or non-volatile memory devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the UE 900. The power component 906 may include a power management system, one or more power sources, and any other components associated with the generation, management, and distribution of power in the UE 900.

The multimedia component 908 includes a screen providing an output interface between the UE 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a wake-up time and a pressure associated with the touch or swipe action. In some embodiments, the multimedia component 908 includes a front camera and/or a rear camera. The front camera and/or the rear camera may receive an external multimedia datum while the UE 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (MIC) configured to receive an external audio signal when the UE 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 913 includes one or more sensors to provide status assessments of various aspects of the UE 900. For instance, the sensor component 913 may detect an open/closed status of the device 900, relative positioning of components, e.g., the display and the keypad, of the UE 900, a change in position of the UE 900 or a component of the UE 900, a presence or absence of user contact with the UE 900, an orientation or an acceleration/deceleration of the UE 900, and a change in temperature of the UE 900. The sensor component 913 may include a proximity sensor configured to detect the presence of nearby objects without any physical contact. The sensor component 913 may also include a light sensor, such as a CMOS or CCD image sensor, for use in imaging applications. In some embodiments, the sensor component 913 may also include an acceleration sensor, a gyroscope sensor, a magnetic sensor, a pressure sensor, or a temperature sensor.

The communication component 916 is configured to facilitate communication, wired or wirelessly, between the UE 900 and other devices. The UE 900 can access a wireless network based on a communication standard, such as WiFi, 2G or 3G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the UE 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

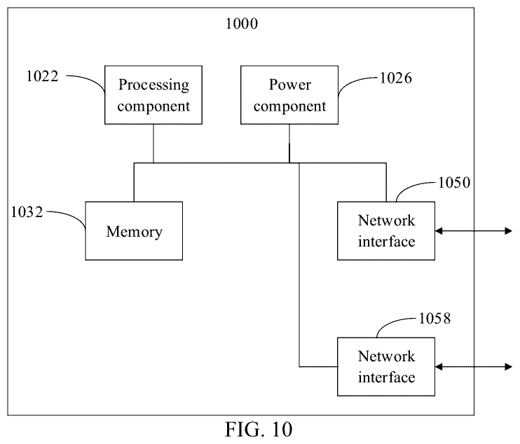

FIG. 10 is a block diagram of a base station 1000 provided in an embodiment of the present disclosure. For example, the base station 1000 may be provided as a base station. Referring to FIG. 10, the base station 1000 includes a processing component 1022, which further includes at least one processor, and a memory resource represented by a memory 1032 for storing instructions, such as an application program, that may be executed by the processing component 1022. The application program stored in the memory 1032 may include one or more modules, each corresponding to a set of instructions. In addition, the processing component 1022 is configured to execute instructions to perform any of the aforementioned methods applied to the base station, e.g., the method shown in FIG. 1.

The base station 1000 may further include a power component 1026 configured to perform power management of the base station 1000, a wired or wireless network interface 1050 configured to connect the base station 1000 to the network, and an input/output (I/O) interface 1058. The base station 1000 may operate based on an operating system stored in the memory 1032, such as a Windows Server™, a Mac OS X™, a Unix™, a Linux™, a Free BSD™ or the like.

In the above-described embodiments provided in the present disclosure, the methods provided in the embodiments of the present disclosure are described from the perspectives of the base station, the UE, and the RIS array respectively. In order to implement various functions in the methods provided by the above embodiments of the present disclosure, the base station and the UE may include hardware structures and software modules, and implement the above functions in the form of the hardware structures, the software modules, or a combination of the hardware structures and the software modules. A certain function in the above described functions may be executed in the form of the hardware structures, the software modules, or a combination of the hardware structures and the software modules.

In the above-described embodiments provided in the present disclosure, the methods provided in the embodiments of the present disclosure are described from the perspectives of the base station, the UE, and the RIS array respectively. In order to implement various functions in the methods provided by the above embodiments of the present disclosure, the network side device and the UE may include hardware structures and software modules, and implement the above functions in the form of the hardware structures, the software modules, or a combination of the hardware structures and the software modules. A certain function in the above described functions may be executed in the form of the hardware structures, the software modules, or a combination of the hardware structures and the software modules.

An embodiment of the present disclosure provides a communication apparatus. The communication apparatus may include a transceiver module and a processing module. The transceiver module may include a sending module and/or a receiving module, the sending module is used to implement a sending function, the receiving module is used to implement a receiving function, and the transceiver module may implement the sending function and/or the receiving function.

The communication apparatus may be a terminal device (such as the terminal device in the aforementioned method embodiments), or an apparatus in the terminal device, or an apparatus that may be used in conjunction with the terminal device. Alternatively, the communication apparatus may be a network device, or an apparatus in the network device, or an apparatus that may be used in conjunction with the network device.

An embodiment of the present disclosure provides another communication apparatus. The communication apparatus may be a network device, or a terminal device (such as the terminal device in the aforementioned method embodiments), or a chip, a chip system, a processor, or the like that supports the network device to implement the aforementioned methods, or a chip, a chip system, a processor, or the like that supports the terminal device to implement the aforementioned methods. The apparatus may be used to implement the method described in the aforementioned method embodiments, and the details may refer to the description in the aforementioned method embodiments.

The communication apparatus may include one or more processors. The processor may be a general-purpose processor or a specialized processor, etc. For example, it may be a baseband processor or a central processor. The baseband processor may be used to process the communication protocols and communication data, and the central processor may be used to control the communication apparatus (such as a network side device, a baseband chip, a terminal device, a chip of the terminal device, a DU or a CU, etc.), execute computer programs, and process the data of the computer programs.

Optionally, the communication apparatus may further include one or more memories, on which a computer program may be stored, and the processor executes the computer program so that the communication apparatus performs the method described in the above method embodiments. Optionally, data may also be stored in the memory. The communication apparatus and the memory may be provided separately or integrated together.

Optionally, the communication apparatus may further include a transceiver and an antenna. The transceiver may be referred to as a transceiver unit, a transceiver, or a transceiver circuit, etc., and is used to implement the transceiver function. The transceiver may include a receiver and a sender, the receiver may be referred to as a receiving machine or a receiving circuit, etc., and is used to implement the receiving function; the sender may be referred to as a sending machine or a sending circuit, etc., and is used to implement the sending function.

Optionally, the communication apparatus may further include one or more interface circuits. The interface circuit is used to receive code instructions and transmit them to the processor. The processor runs the code instructions to enable the communication apparatus to execute the method described in the above method embodiments.

When the communication apparatus is a terminal device (such as the terminal device in the aforementioned method embodiments), the processor is used to execute the methods shown in any one of FIGS. 1 to 4.

When the communication apparatus is a network device, the transceiver is used to execute the methods shown in any one of FIGS. 5 to 6.

In one implementation, the processor may include a transceiver for implementing the receiving and sending functions. For example, the transceiver may be a transceiver circuit, or an interface, or an interface circuit. The transceiver circuit, interface, or interface circuit for implementing the receiving and sending functions may be separate or integrated. The above-mentioned transceiver circuit, interface, or interface circuit may be used for reading and writing code/data, or the above-mentioned transceiver circuit, interface, or interface circuit may be used for transmitting or delivering signals.

In one implementation, the processor may store a computer program, which runs on the processor and enables the communication apparatus to perform the methods described in the above method embodiments. The computer program may be cured in the processor, in which case the processor may be implemented by hardware.

In one implementation, the communication apparatus may include a circuit that may implement the functions of sending, receiving, or communicating in the aforementioned method embodiments. The processor and transceiver described in the present disclosure may be implemented in an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be manufactured using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), a silicon germanium (SiGe), a gallium arsenide (GaAs), etc.

The communication apparatus described in the above embodiments may be a network device or a terminal device (such as the terminal device in the aforementioned method embodiments), but the scope of the communication apparatus described in the present disclosure is not limited thereto, and the structure of the communication apparatus may not be limited thereto. The communication apparatus may be an independent device or may be part of a relatively large device. For example, the communication apparatus may be:
(1) an independent integrated circuit (IC), or a chip, or a chip system or a subsystem;
(2) a collection of one or more ICs, optionally, the collection of ICs may also include a storage component for storing data, computer programs;
(3) an ASIC, such as a modem;
(4) a module that can be embedded in other device;
(5) a receiver, a terminal device, a smart terminal device, a cellular phone, a wireless device, a handheld device, a mobile unit, a vehicle-mounted device, a network device, a cloud device, an artificial intelligence device, etc.;
(6) others.

In the case where the communication apparatus may be a chip or a chip system, the chip includes a processor and an interface, where the number of the processor may be one or more, and the number of the interface may be more than one.

Optionally, the chip further includes a memory for storing necessary computer programs and data.

Those skilled in the art may also understand that the various illustrative logical blocks and steps listed in the embodiments of the present disclosure may be implemented by electronic hardware, computer software, or a combination of the two. Whether such functions are implemented by hardware or software depends on the specific application and the design requirements of the entire system. Those skilled in the art may use various methods to implement the functions described for each specific application, but such implementation should not be understood as going beyond the scope of protection of the embodiments of the present disclosure.

An embodiment of the present disclosure further provides a system for indicating repetition transmission of a physical channel, the system includes the communication apparatus acting as the terminal device (such as the first terminal device in the aforementioned method embodiments) and the communication apparatus acting as the network device in the aforementioned embodiments.

The present disclosure further provides a readable storage medium with instructions stored thereon, and the functions of any of the above method embodiments are implemented when the instructions are executed by a computer.

The present disclosure further provides a computer program product, which implements the functions of any of the above method embodiments when executed by a computer.

In the above embodiments, it may be implemented in whole or in part by software, hardware, firmware or any combination thereof. When implemented by software, it may be implemented in whole or in part in the form of a computer program product. The computer program product includes one or more computer programs. When the computer program is loaded and executed on a computer, the process or functions according to the embodiments of the present disclosure, in whole or in part, are generated. The computer may be a general-purpose computer, a special-purpose computer, a computer network, or other programmable apparatus. The computer program may be stored in a computer-readable storage medium, or transmitted from one computer-readable storage medium to another computer-readable storage medium. For example, the computer program may be transmitted from one website site, computer, server or data center by a wired (e.g., coaxial cable, optical fiber, digital subscriber line (DSL)) or wireless (e.g., infrared, wireless, microwave, etc.) manner to another website site, computer, server or data center. The computer-readable storage medium may be any available medium that may be accessed by a computer or a data storage device such as a server or data center that contains one or more available medium integrated. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)), etc.

A person of ordinary skill in the art may understand that the various numerical numbers such as “first” and “second” involved in the present disclosure are only used for distinction for convenience of description and are not used to limit the scope of the embodiments of the present disclosure as well as to indicate the order of precedence.

The term “at least one” in the present disclosure may also be described as “one or more”, and the term “a plurality of” may refer to two, three, four or more, which is not limited in the present disclosure. In the embodiments of the present disclosure, for a type of technical feature, the technical features in this type of technical feature are distinguished by the terms “first”, “second”, “third”, “A”, “B”, “C” and “D”, etc., and there is no order of precedence or magnitude between the technical features described by the “first”, “second”, “third”, “A”, “B”, “C” and “D”.

Those skilled in the art will readily appreciate other embodiments of the present disclosure after considering the specification and practicing the disclosure disclosed herein. The present disclosure is intended to cover any variations, uses or adaptations of the present disclosure that follow the general principles of the present disclosure and include common knowledge or customary techniques in the art that are not disclosed in the present disclosure. The specification and the embodiments are considered exemplary only, and the true scope and spirit of the present disclosure are indicated by the appended claims.

It should be understood that the present disclosure is not limited to the exact structures that have been described above and shown in the accompanying drawings, and various modifications and changes may be made without departing from the scope thereof. The scope of the present disclosure is limited only by the appended claims.

1. A method for indicating repetition transmission of a physical channel, performed by a user equipment (UE), comprising:
receiving configuration information for repetition transmission sent by a network device;
determining a transmission resource for the repetition transmission according to the configuration information, wherein the transmission resource is discontinuous in time; and
determining a repetition transmission opportunity according to the transmission resource.

2. The method according to claim 1, wherein receiving the configuration information for the repetition transmission sent by the network device comprises:
receiving a corresponding relationship between indication information and the transmission resource sent by the network device via a first signaling; and
receiving the indication information sent by the network device via a second signaling.

3. The method according to claim 2, wherein the transmission resource comprises at least one of:
a total number of the repetition transmission;
a time interval between each repetition transmission opportunity;
a number of the repetition transmission transmitted at each repetition transmission opportunity; or
pattern information of the repetition transmission.

4. The method according to claim 3, wherein determining the transmission resource for the repetition transmission according to the configuration information comprises:
determining a corresponding transmission resource based on the corresponding relationship in the first signaling and the indication information comprised in the second signaling.

5. The method according to claim 1, wherein the configuration information comprises the transmission resource for the repetition transmission; and
the transmission resource comprises at least one of:
a total number of the repetition transmission;
a time interval between each repetition transmission opportunity;
a number of the repetition transmission transmitted at each repetition transmission opportunity; or
pattern information of the repetition transmission.

6. The method according to claim 5, wherein receiving the configuration information for the repetition transmission sent by the network device comprises:
receiving the configuration information sent by the network device via a third signaling,
wherein the third signaling is an RRC signaling;
receiving the configuration information sent by the network device via the third signaling comprises any one of:
receiving the configuration information sent by the network device via an RRC signaling for configuring semi-persistent scheduling (SPS);
receiving the configuration information sent by the network device via an RRC signaling for configuring a physical uplink shared channel (PUSCH) configured grant Type 1; and
receiving the configuration information sent by the network device via an RRC signaling for configuring a physical channel.

7. (canceled)

8. The method according to claim 5, wherein receiving the configuration information for the repetition transmission sent by the network device comprises:
receiving the configuration information sent by the network device via a fourth signaling,
wherein the fourth signaling is a DCI signaling;
receiving the configuration information sent by the network device via the DCI signaling comprises any one of:
receiving the configuration information sent by the network device via a DCI signaling for activating SPS; and
receiving the configuration information sent by the network device via a DCI signaling for activating PUSCH configured grant type 2.

9. (canceled)

10. The method according to claim 1, wherein in response to the transmission resource comprised in the configuration information being a total number of the repetition transmission, determining the transmission resource for the repetition transmission according to the configuration information comprises:
determining the transmission resource according to predefined information and the configuration information;
wherein the predefined information is configured to determine at least one of:
a time interval between each repetition transmission opportunity;
a number of the repetition transmission transmitted at each repetition transmission opportunity; or
pattern information of the repetition transmission.

11. The method according to claim 2, wherein the transmission resource corresponding to the indication information carried in the configuration information comprises a total number of the repetition transmission, and determining the transmission resource for the repetition transmission according to the configuration information comprises:
determining the transmission resource according to predefined information and the configuration information;
wherein the predefined information is configured to determine at least one of:
a time interval between each repetition transmission opportunity;
a number of the repetition transmission transmitted at each repetition transmission opportunity; or
pattern information of repetition transmission.

12. The method according to claim 1, wherein the repetition transmission of the physical channel comprises at least one of:
repetition transmission of a physical uplink shared channel (PUSCH);
repetition transmission of a physical downlink shared channel (PDSCH);
repetition transmission of a physical uplink control channel (PUCCH); or
repetition transmission of a physical downlink control channel (PDCCH).

13. The method according to claim 1, further comprising:
performing the repetition transmission based on the repetition transmission opportunity.

14. A method for indicating repetition transmission of a physical channel, performed by a network device, comprising:
sending configuration information for repetition transmission to a UE.

15. The method according to claim 14, wherein sending the configuration information for the repetition transmission to the UE comprises:
sending a corresponding relationship between indication information and a transmission resource to the UE via a first signaling; and
sending the indication information to the UE via a second signaling,
wherein the transmission resource comprises at least one of:
a total number of the repetition transmission;
a time interval between each repetition transmission opportunity;
a number of the repetition transmission transmitted at each repetition transmission opportunity; or
pattern information of the repetition transmission.

16. (canceled)

17. The method according to claim 14, wherein the configuration information comprises a transmission resource for the repetition transmission; and
the transmission resource comprises at least one of:
a total number of the repetition transmission;
a time interval between each repetition transmission opportunity;
a number of the repetition transmission transmitted at each repetition transmission opportunity; or
pattern information of the repetition transmission.

18. The method according to claim 17, wherein sending the configuration information for the repetition transmission to the UE comprises:
sending the configuration information to the UE via a third signaling,
wherein the third signaling is an RRC signaling;
sending the configuration information to the UE via the third signaling comprises any one of:
sending the configuration information to the UE via an RRC signaling for configuring SPS;
sending the configuration information to the UE via an RRC signaling for configuring a PUSCH configured grant Type 1; and
sending the configuration information to the UE via an RRC signaling for configuring a physical channel.

19. (canceled)

20. The method according to claim 17, wherein sending the configuration information for the repetition transmission to the UE comprises:
sending the configuration information to the UE via a fourth signaling,
wherein the fourth signaling is a DCI signaling,
sending the configuration information to the UE via the fourth signaling comprises any one of:
sending the configuration information to the UE via a DCI signaling for activating SPS; and
sending the configuration information to the UE via a DCI signaling for activating a PUSCH configured grant type 2.

21. (canceled)

22. The method according to claim 13, further comprising:
receiving the repetition transmission from the UE.

23. The method according to claim 14, wherein the repetition transmission of the physical channel comprises at least one of:
repetition transmission of a PUSCH;
repetition transmission of a PDSCH;
repetition transmission of a PUCCH; or
repetition transmission of a PDCCH.

24. (canceled)

25. (canceled)

26. A communication apparatus, wherein the apparatus comprises a processor and a memory, a computer program is stored in the memory, and the processor executes the computer program stored in the memory to cause the apparatus to perform:
receiving configuration information for repetition transmission sent by a network device;
determining a transmission resource for the repetition transmission according to the configuration information, wherein the transmission resource is discontinuous in time; and
determining a repetition transmission opportunity according to the transmission resource.

27. A communication apparatus, wherein the apparatus comprises a processor and a memory, a computer program is stored in the memory, and the processor executes the computer program stored in the memory to cause the apparatus to perform the method according to claim 14.

28.-31. (canceled)
